(19) United States
(12) Patent Application Publication
(10) Pub. No.: US 2011/0153121 A1
(43) Pub. Date: Jun. 23, 2011

(54) SECURED AREA ACCESS SYSTEM, APPARATUS, AND METHOD

(76) Inventor: Minas Minassian, Vista, CA (US)

(21) Appl. No.: 13/010,315

(22) Filed: Jan. 20, 2011

Related U.S. Application Data
(63) Continuation-in-part of application No. 11/936,002, filed on Nov. 6, 2007, now abandoned.

(51) Int. Cl. G08B 29/00; G06F 7/00

(52) U.S. Cl. 701/2; 340/5.64

(57) ABSTRACT

A secured area access system for providing access to a protected area is disclosed. In one embodiment, a vehicle access security system, comprising a transmitter, a detector, an access controller module is taught, wherein the transmitter transmits a modulated secured area access signal into an acoustic or optical communications channel, which is detected by the detector. The detector is adapted to detect the modulated vehicle access signal and further adapted to have a detector output signal. An access controller module receives the detector output signal and performs at least one signal processing function. The access controller compares the processed signal against a encoded signal stored in the memory and if it matches send a unlock signal to the locking mechanism of the secured area, granting access to the area. The system may also emulated a transponder code to authorize a start signal

### RELATION TO OTHER PATENTS

This application is a continuation in part of U.S. patent application Ser. No. 11/936,002, filed on Nov. 6, 2007.

### BACKGROUND

1. Field

The present disclosure generally relates to apparatuses, systems and methods for accessing a secured area, such as a vehicle, home or building.

2. Related Art

Security and convenience are two fundamental objectives that drive the use of secured access systems, both for vehicles and buildings. As electronics, telecommunication and computer networking matures, secured access system designer have adopted these technologies to enhance functional features for both security and convenience aspects. Short range radio frequency receivers and transceivers, such as for example one-way key FOBs, transponders, and hand-held two way transceivers with displays and sophisticated software are commonly used to grant a user access to a vehicle, home, or office. Additionally, cell phones and other long range wireless technologies have become more wide spread for controlling secured access systems. Such short range radio frequency and long range cell phone devices have become a primary access tool, largely replacing older metallic keys previously used to access a vehicle or a home.

One issue that has only received minimal attention is backup solutions for access if a user is locked out of his/her vehicle, home or office. Such locked out situations can occur when a user locks his/her keys or key FOB in a vehicle or walks out of the house and locks the door, without a key to reenter the premises. One solution to address the issue of backup accessibility has been to hide a physical key locally, such as for example on the vehicle body, or under a planter located close to a user's home porch. Such solutions may further compromise security, as a burglar may access such backup solutions to gain unauthorized entry. Further, hiding a FOB has the same issues and security concerns.

Another solution to the backup issue has been to provide a key pad on the vehicle door or house door. However, if the keypad is rarely used the password can be easily forgotten. Forgotten key passwords can thwart such backup access.

Another approach has been to use telematics type technology such as On-Star®' Tele Aid®^{,} Viper Smartstart® to request access to a secured area by sending a wireless function command signals to a secured access system through a cellular telephone network. U.S. Pat. No. 7,672,666 issued to Hasan is an example of one such system, and the disclosure of Hasan is fully incorporated by reference herein.

Another example of a system that uses a cellular telephone network to authenticate a spare key, allowing access to a secured vehicle is disclosed in U.S. Pat. No. 6,847,286 issued to Bartz, and its related patent U.S. Pat. No. 7,002,450, both are fully incorporated herein by reference. Bartz describes a method that authenticates a spare key for a vehicle by sending coded short range RF signals from a spare key to a receiver in a vehicle. The vehicle has a cell phone associated with the receiver and when the receiver receives an identification signal from the spare key, the cell phone calls a central database to confirm the authenticity of the spare key, that it is properly associated with the particular vehicle and then the system provides an authorization signal for the vehicle to accept the spare key. However, this system still requires a physical key that the user must verify through the disclosed method.

There are a number of short comings with the prior art systems. All systems based on replacing the original key that allows access to the secured area require that a spare physical key or key FOB be in the possession of the user. It is very easy to lose the spare key, or worse have the key taken by a thief. Additionally, a key that incorporates a transponder must be learned or programmed into the access system, often inconveniently requiring the user to take the vehicle to a dealer or have a technician come on site. Thus, there is a need to have an access system that does not require the user to possess a physical key or have a new key programmed.

For systems that rely on long range cellular technology, a primary limitation of the technology is that you must have an independent cell phone receiver permanently associated with the system controlling the entry point of the vehicle, home or building, separate from a cell phone used for day to day communication purposes. This requires an additional subscription to maintain the vehicle cell phone on the cell phone network, materially increasing the costs of such systems. Additionally, if the cell phone associated with the access point is in a location that is limited in cell phone signal reception because there is not a convenient cell tower in range or because there is an obstruction that blocks the signal, the command signal sent from the cell phone network to unlock the access point may not be received and the access point will remain locked. Thus, there is a need for a system for unlocking an access point that does not rely on long range cell phone networks.

Therefore a need exists for a solution to the aforementioned problem of providing a backup security access system, which is inexpensive, reliable, easy to install, and easy to use. The present teachings provide such an access system.

### SUMMARY

In view of the foregoing background, it is therefore an object of the invention to provide a secured area access system, such as for a vehicle, home or building.

This and other objects, features and advantages in accordance with the present invention are provided including a secured area access system and method for allowing access to the interior of a protected area such as a vehicle interior, a home or building. The system provides for an encoded acoustic or optical signal generator, the generated signal is detected by the sensor associated with the locking mechanism of the secured area, if the signal is authorized the locking mechanism is put in an unlock mode. The signal can be produced by a variety of acoustic or optical devices. The system may be incorporated into a vehicle with a secured access area and an ignition circuit. The ignition circuit incorporates a charging circuit for providing a transduction charge to a transponder, which is generally embedded in a door/ignition key, a coded signal transmitter, a detector, a processor module, and a transponder simulation module.

In one aspect of the invention, a cellular telephone with a speaker and display is provided having the capability to present optically encoded light flashes or acoustically encoded audible tone sequences to a detector located at an access point. The coded sequence amplified and providing a security code to a security system associated with a locking mechanism for the unlocking the access point and providing entry access. The coded sequence also providing a signal to a transponder simulator module for simulating an ignition key code.

In one aspect of the invention, a user can use an electronic device such as a computer, cell phone, watch, or other well know type of electronic device with appropriate speaker, flash, and software to select either a coded acoustic sequence or a coded optical light flash sequence and communicating the selected code to detector associated an access point locking mechanism. The coded sequence can be randomly generated or user selected providing a security code for unlocking the secured access point to provide entry.

In another aspect of the invention the user can download a cell phone app from the internet and use the app to select a format and coded acoustic sequence or optical light flash sequence. The coded sequence can be randomly generated or user selected providing a security code for unlocking the secured access point to provide entry. Coding of the signal can be accomplished by modulation of the signal amplitude or frequency. To add security the coded sequence can be a combination of both acoustic and optical signals chosen by the user or randomly created by the app.

In another aspect of the invention the coded optical or acoustical signal of the system is adapted to be manipulated by at least one signal processing function selected from the group consisting of, (i.) amplifying an amplitude of the signal, (ii.) down-converting the signal, (iii.) demodulating the signal, or (iv.) correcting phase distortions in the signal.

Another aspect of the invention provides a system and method to bypass in a vehicle equipped with a transponder based passive antitheft device and allow starting of a vehicle. The system learns the transponder code and simulates the transponder code when an appropriate coded sequence is received, allowing access to and engine starting of a vehicle.

In another aspect of the invention, the access system provides a processor, adapted to accept the signal and to compare the signal with a pre-authorized access code stored in a memory and if comparative results match then sending an access authorization and unlock code to the access area locking mechanism.

In one embodiment a security access system is disclosed, comprising a signal transmission device, adapted to transmit a modulated access signal into a randomly generated or predetermined communications channel, the communications channel selected from a group consisting of, (i.) an acoustic communications channel, or (ii.) an optical communications channel. The security access system further comprising an acoustic or optical detector, adapted to detect the modulated access signal in the communications channel transmitted by the transmission device. The detector outputting a signal. The security access system further comprising a signal processing module, adapted to receive the detector output signal, the signal processing module further adapted to perform at least one signal processing function, the signal processing function selected from the group consisting of, (i.) amplifying an amplitude of the detector output signal, (ii.) down-converting the detector output signal, (iii.) demodulating the detector output signal, or (iv.) correcting phase distortions in the detector output signal. The signal processing module further comprising a computational element, adapted to accept the detector output signal and compare the output signal with an authorized access code previously stored in memory accessible by the signal processing module, and whereby the signal processing module further calculates an output value of the computational element reflective of a comparative result of the receiver output signal with the predetermined access code.

### BRIEF DESCRIPTION OF THE DRAWINGS

Embodiments of the present disclosure will be more readily understood by reference to the following figures, in which like reference numbers and designations indicate like elements.

FIG. 1 illustrates one embodiment of a secured vehicle access security system according to the present teachings.

FIG. 2 is a schematic representation of the secured vehicle access security system according to the present invention.

FIG. 3 is a schematic representation of the computer based programming aspects of the present teachings.

FIG. 4 illustrates logic for creating and authorizing coded signals using a smart phone or computer according to the present teachings.

FIG. 5 illustrates logic for programming a encoded signal into the memory of the system according to the present teachings.

### DETAILED DESCRIPTION OF THE PREFERRED EMBODIMENTS

The present invention provide for a secured area access system for providing access to an area secured by a locking mechanism. The system includes a user held device capable of generating an optically or acoustically encoded signal that is transmitted to an optical or acoustical sensor in communication with a controller capable of signal modulation. If the received signal is authorized by comparing and matching against a coded signal in memory, a control signal is provided to the locking mechanism to unlock.

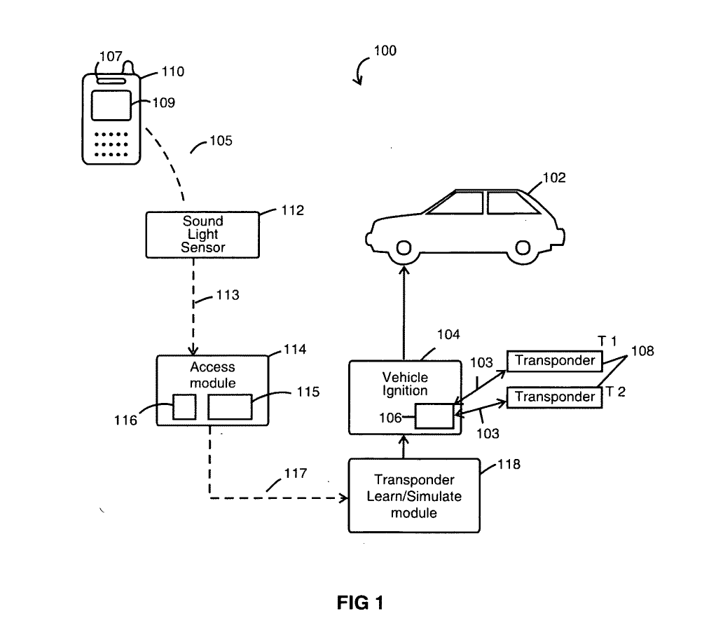

The present invention will now be described more fully hereinafter with reference to the accompanying drawings in which preferred embodiments of the invention are shown. This invention may, however, be embodied in many different forms and should not be construed as limited to the illustrated embodiments disclosed. Rather, these embodiments are provided so that this disclosure will be thorough and complete, and will fully convey the scope of the invention to those skilled in the art. Like numbers refer to like elements throughout. The access system will now be described in detail, with reference made to FIGS. 1-6.

Referring now to the drawings where the showings are for purposes of illustrating the preferred embodiments of the invention-only and not for purposes of limiting the same. FIG. 1 provides one view of an embodiment of a secured vehicle access system 100. In the embodiment of FIG. 1, the secured vehicle access system 100 comprises a vehicle with a secured access area 102 and engine ignition circuit 104, the ignition circuit incorporates a charging circuit 106 for providing a transduction charge to a transponder 108, which is generally embedded in a door/ignition key, a coded signal transmitter 110, a detector 112, a processor module 114, and a transponder simulation module 116.

The coded signal transmitter 110 can be any electronic device capable of transmitting optical flashes or acoustical tones, but it preferably is a standard smart phone such as an iPhone, Droid or Blackberry device. The coded signal transmitter 110 uses the smart phone's display 109 or camera flash (not shown) for generating series of light flashes that encode an optical signal and the smart phone's speaker 107 to generate acoustical tones for encoding an acoustical signal. The coded signal transmitter 110 can be programmed by a user to transmit coded signals either by selecting a series of modulated optical flashes, a set of modulated acoustical tones or a combination of either that represent an authorized access code. The user can also use a signal generator to random code for the signal. The modulated vehicle access signal 105 may comprise a modulation format, such as for example frequency modulation, amplitude modulation, phase modulation, quadrature phase shift keying, quadrature amplitude modulation, frequency shift keying, on-off keying, or literally any other form of modulation scheme. The coded signal can be chosen using a software application (app) downloaded from the internet and stored locally on the smart phone.

In one embodiment, the predetermined communications channel can consist of an acoustic speaker 107 and a microphone 112, capable of receiving for example, inter alia, an audio channel or an ultrasonic channel, wherein the modulated access signal 105 comprises an audio signal adapted for transmission into the audio communications channel. In some embodiments, an acoustic signal generator, such as for example an analog or digital audio player device such as an MP3 player or a wireless telephone 110 is used to generate the modulated encoded access signal 105. Literally any source capable of generating an audio signal may be used to generate the modulated encoded access signal 105 for transmission into the acoustic communications channel.

In another embodiment, the predetermined communications channel can consist of a cell phone LCD screen 109 capable of flashing light sequences and a photoelectric cell 112, capable of receiving for example, inter alia, an infrared communications channel, a visible light communications channel, a visible light communications channel, or an ultraviolet communications channel wherein the modulated encoded access signal 105 comprises an encoded optical signal adapted for transmission to a photoelectric cell 112. In some embodiments, an optical signal generator such as for example a cellular telephone display or camera flash is used to generate the optically modulated encoded access signal 105.

The detector 112 is adapted to detect the modulated vehicle access signal 105 in the predetermined communications channel transmitted by the smart phone 110. The detector 112 can be any light detector such as a photoelectric cell capable of detecting light flash sequences, intensity and duration or any microphone capable of detecting tone, both are commonly known. The signal 105 can be a song snippet, a series of tones or other sound sequences that encode a message. The series of tone can be generated by using the number keys of the phone, randomly generated by the system, or selected from stored files.

The detector 112 generates a detector output signal 113. In one embodiment, the acoustic transducer 112 transforms the acoustic signal 105 into an electrical waveform 113. In other embodiments, the acoustic transducer 112 detects the acoustic signal 105 and outputs an acoustic waveform 113 correlated to the acoustic signal. In other variations, the detector 112 comprises an photoelectric cell. In this embodiment, the modulated vehicle access signal 105 comprises an optical signal, which can be a series of flashes of varying flash duration, speed, or intensity. The optical transducer 112 is adapted to detect the optical signal 105 in the optical communications channel. In one embodiment, the optical transducer 112 is adapted to transform the optical signal 105 into an electrical waveform 113. In other embodiments, the optical transducer element is adapted to transform the optical signal into, inter alia, an acoustic waveform or an optical waveform.

The access control module 114 is adapted to receive the detector output signal 113 of the detector 112. The access control module 114 is further adapted to perform at least one signal processing function. In one embodiment, the signal processing function comprises, inter alia, amplifying an amplitude of the detector output signal 113, down-converting the detector output signal 113, demodulating the detector output signal 113, and/or correcting phase distortions in the detector element output signal 113.

The access control module further comprises an internal processor 115, adapted to accept the detector output signal 113, and a memory 116. The processor 115 can be any well known microcontroller, and the memory 116 can be any well known type memory. The memory device may be, inter alia, a EEPROM, magnetic storage medium, an optical storage medium, a semiconductor memory element, a compact disk element, a digital video disk element, an internet based database element such as the Internet, or a computer readable medium. The processor 115 is further adapted to compare the detector output signal 113 with a predetermined access code, wherein the predetermined access code is stored in the memory 116 and accessible by the processor 115. The access control module 114 outputs an access control module output signal 117. The access control module 114 calculates an output value 117, reflective of a comparative result of the detector output signal 113 with the predetermined access code that has been previously stored in memory 116. For example, if the detector output signal 113 matches the predetermined access code an unlock door message will be sent.

In some embodiments, the system may also include a transponder learn/simulator (TLS) module 118. The TLS module will include a receiver coil and a memory (both not shown). Alternatively, the memory 116 of the access control module 114 may be used. In a vehicle with a transponder chip 108 imbedded into the vehicle key, the vehicle key must be proximally located near the vehicle ignition switch 104 to receive an electric charge from a transduction coil 106 located at the ignition switch. Upon receipt of the charge by the transponder 108 a coded signal 103 will be discharged from the transponder 108 and transmitted back to the transduction coil 106 near the ignition switch. If the signal matches the code of the vehicle, a vehicle start signal will be issued from the ignition. In the preferred embodiment of the current invention, a TLS module 118 is placed near the transponder coil 106. When the transponder 108 within the vehicle key is placed near the vehicle's transduction coil 106 and transmits the transponder identification signal 103, the TLS module 118 will receive the transponder signal 103 and store it in memory for later use.

If the detector output signal value 113 matches the predetermined access code stored in memory 116, the access security module 114 sends a door unlock message to the vehicle door lock mechanism through the vehicles data bus ignition control module (not shown). If, on the other hand, the detector output signal value 113 does not appropriately match the predetermined access code stored in memory 116, no door unlock message is sent and a user is denied access to the vehicle's secured interior. The vehicle data bus is a factory installed bus system. It is contemplated that the current invention may also be factory installed and part of the factory installed bus system, or it may be aftermarket and interfaced on a retrofit basis with the factory bus system.

In one embodiment, granting access to the vehicle comprises unlocking one or more doors of the vehicle. In another embodiment, the modulated vehicle access signal 105 may include instruction to both unlock the vehicle door and to start the vehicle motor. When the detector 112 receives a vehicle start message as part of the instructions received from the smart phone 110, the detector output signal 113 will likewise include such instructions and encode a detector output signal 113 with a vehicle start signal. When a vehicle start signal is a component of the detector output signal 113 the processor 115 retrieves the transponder code, previously captured from the transponder 108 and stored in memory 116, and sends a signal 117 to the TLS module 118 to simulate a vehicle start signal. Because the transponder code is incorporated into the vehicle start signal the vehicle recognizes the code and authorized starting of the vehicle. Scope of the term “vehicle” is intended to comprise, inter alia, automobiles, cars, trucks, vans, boats, trains, motorcycles, recreational vehicle, mobile home, trailer, and literally any other mode of transportation for which such a vehicle security module may be useful. In another embodiment, the vehicle may also need to be started without the vehicle key. In such a case, when the access module 114 receives a authorized detector output signal the TLS module

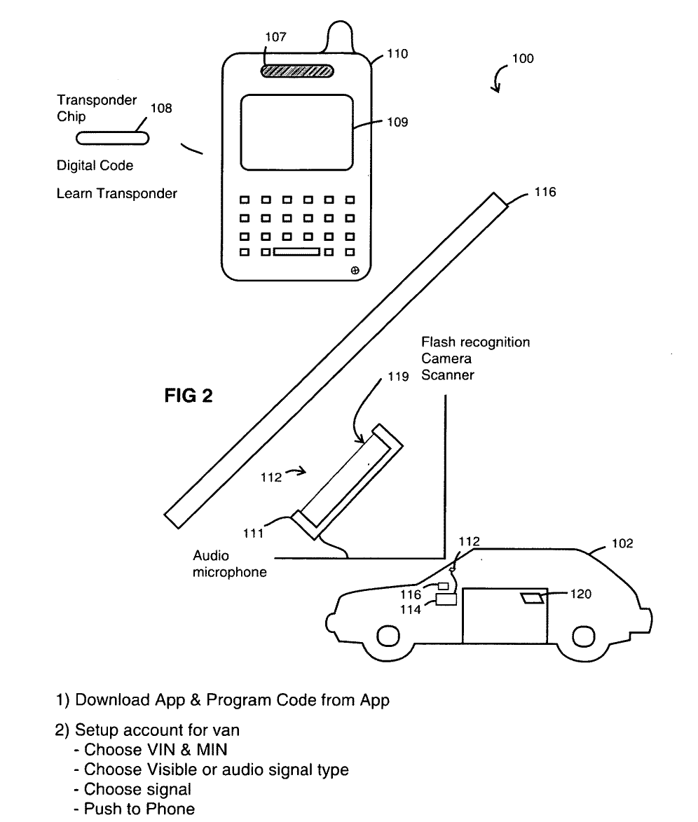

With further reference to FIG. 1 and with reference to FIG. 2, the vehicle security access system 100 is adapted to detect, in a predetermined communications channel, an encoded modulated vehicle access signal 113 transmitted from an encoded signal transmitter 110. The encoded transmission device is a cellular phone 110 with a speaker 107 and a display 109. The detector 112, can incorporate both a microphone 111 with an embedded photoelectric cell 119. In one embodiment, the detector 112 is placed under the windshield 116 of the vehicle 102. FIG. 2 shows a blown up view of the detector 112 on the dash and under the windshield 116 of a vehicle 102. The access control module 114 can be conveniently installed under the vehicle dash or other inconspicuous location within the vehicle, such as behind the door panel. The various modules of the system of the current invention may communicate either by direct wired connection over a bus system or wirelessly by short range radio frequency systems such as Bluetooth.

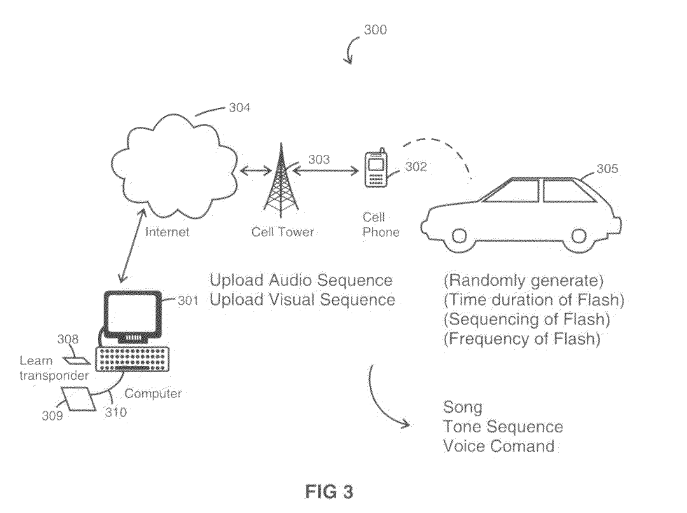

Referring now to FIG. 3, FIG. 3 depicts a representation of a wireless communications network 300 for encoding and transferring to cell phone 302 the coded signal that is transmitted by the wireless device 302 to the detector located in a vehicle 305. The coding of the encoded optical flash or audible tone sequence can be user programmed or randomly generated using software residing on a computer 301, the smart phone 302, or a hosted server on the internet 304. A software application can be downloaded as an app over the cell phone network 303 or mobile website residing on the internet 304. Preferably, the software resides on the cell phone 302, which can be used to select from coded signal generated from a dial pad, a ring tone, or library of music stored on the cell phone 302, a computer 301 or hosted website 304. It will be appreciated by one skilled in the art that the software can also reside on a hosted server 304 or a home computer 301. The user's music selection, a ring tone, a song, a series of song snippets or tones generated by the ten-key pad can be associated with optical flashes of different durations and intensities or frequencies. Thus, a user can select tones that art translated by the app to flash sequences and used for the encoded signal. For embodiments of the current inventions that are used with vehicles having a transponder based anti-theft system, a transduction coil module 309 can be interfaced via USB or similar interface cable 310 to the computer 301 or the cell phone 302. The app will send instructions to allow power to the transduction coil module 309 supplied through the USB cable 310. The transduction coil module 309 will charge the transponder 308 and upon charging the transponder 308 will send the vehicle identification code back to the transduction coil module 309, which transfers the vehicle identification code to the computer 301 or cell phone 302 and is stored in memory for encoding and later use with the system.

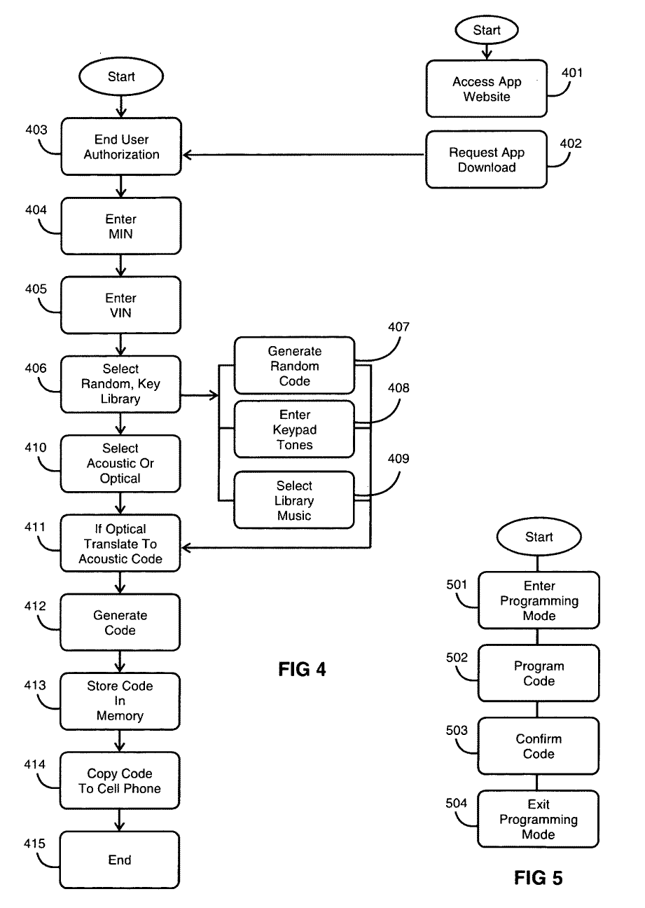

Now with reference to FIG. 4, the preferred embodiment uses a software application to assist the user to generate the encoded signal. The logic for the software is set out in FIG. 4. Generally, the application may reside on a hosted server, a computer, or a cell phone, but preferably resides on the cell phone. For embodiments were the app resides on the cell phone the user must install the app on the phone. At 401, the user accesses a hosted website to download the software on to the cell phone. This is done wirelessly and is well known in the art. At 402 the user requests the software and downloads it into the phone. At 403, the software requests the user to set up an access code for authorizing the user to enter the software setting. At 404, the mobile identification number (MIN) of the cell phone is entered into the phone. The MIN will be combined with other data elements to become integral to the encoded signal that will be generated. At 405, the vehicle identification number (VIN) for the vehicle that is intended to be associated with the code is entered. The VIN will also become part of the encoded signal that will be generated. It will be appreciated that the software can be configured to set up multiple vehicles, each vehicle having a unique encoded signal associated for accessing only that vehicle. At 406, the user will be prompted to select from generating the encoded signal randomly by the software 407, generating a code by allowing the user to select a tone sequence by depressing the key-pad on the phone 408, or by selecting a ring tone, a song or snippits of various songs from the users library of music stored on the cell phone 409. If the user prefers an optically encoded signal, at 410, the user can select optical encoding. The software at 411 will translate acoustically encoded signals by associating specific tones with light flash durations, intensities or frequency. At 412, the encoded sequence is generated by the software. In some embodiments, the software can be stored on a hosted server or computer. In such embodiments the user will skip 401 and 401, and at 413 the encoded signal is stored in the memory. For embodiments where the software resides on a host server or computer, the encoded signal is transferred to the cell phone either wirelessly or through a USB cable.

FIG. 5 demonstrates the programming of the encoded signal into the memory 116 of the access control module 114 so that it can be matched during an operating mode. At 501, the access control module is put into a programming mode. The programming mode can be entered by powering up the access control module 114 for the first time, by switching on and off the vehicle ignition switch, or by depressing a switch on the module. Preferably, the programming mode is entered by switching on and off the ignition switch. Once the programming mode is entered, the user presents to the detector 112 the encode signal by placing the cell phone 110 in proximity to the detector 112 and transmitting the encoded signal 105. At 503, the user presents for a second time the encoded signal to confirm that it matches the original presentation. Upon confirmation of matching, the encoded signal is stored in the memory 116 of the access control module 114 and the programming mode is exited. If an encoded signal is not presented within a set time period after entering the programming mode, the programming mode is exited.

The present teachings are useful for providing security to any secured area requiring access including any structure for which a user may desire security comprising, inter alia, a house, building, office, vault, locker, storage area, or trunk.

For further reference regarding enabling security access systems, the following references are incorporated by reference in their entirety, as if disclosed herein in full: U.S. Pat. No. 4,890,108 to Drori et al., entitled, “Multi-Channel Remote Control Transmitter” ; U.S. Pat. No. 5,157,375 to Drori et al., entitled Electronic Vehicle Security System; U.S. Pat. No. 5,650,774 to Drori, entitled, “Electronically Programmable Remote Control Access System” ; U.S. Pat. No. 6,561,151 to Wisnia et al., entitled, “Remote Control Car Starter” ; U.S. Pat. No. 4,887,064 to Drori et al., entitled, “Multi-featured Security System with Self-Diagnostic Capability” ; U.S. Pat. No. 6,467,448 to Wisnia et al., entitled, “Remote Engine Starter System” ; U.S. Pat. No. 4,922,224 to Drori et al., entitled, “Electronic Vehicle Security System” ; U.S. Pat. No. 5,534,845 to Issa et al., entitled, “Advanced Automotive Automation and Security System”.

The foregoing description illustrates exemplary implementations, and novel features, of aspects of an apparatus for accessing a security system. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”

What is claimed is:

1. A secured area access system, comprising:
a) a signal transmitter, the signal transmitter adapted to transmit a encoded optical or acoustic signal;
b) a detector, the detector adapted to detect the encoded optical or acoustic signal and generate a detector output signal;
c) an access controller module in communication with the detector and having a processor and a memory, the access controller module adapted to store in the memory an preselected encoded area access code, receive the detector output signal and perform at least one signal processing function, wherein the at least one signal processing function is selected from the group consisting of:
i) amplifying an amplitude of the detector output signal;
ii) downconverting the detector output signal;
iii) demodulating the detector output signal, or;
iv) correcting phase distortions in the detector output signal, and;
the access controller module further adapted to compare the processed receiver output signal with the preselected encoded area access code stored in the memory, and wherein the controller outputs an unlock signal if the processed receiver output signal matches the encoded area access code.

2. The secured area access system of claim 1, wherein the signal transmitter is selected from the group consisting of: a cellular telephone; an audio player; a wireless telephone; a key FOB; an LCD screen; an optical transmitter, or an audio transmitter.

3. The secured area access system of claim 2, wherein the encoded area access signal is modulated using a modulation format selected from the group consisting of: frequency modulation, amplitude modulation, phase modulation, quadrature phase shift keying, quadrature amplitude modulation, frequency shift keying, or; on-off keying.

4. The secured area access system of claim 1, wherein the signal transmitter comprises a memory, a processor, a speaker capable of generating acoustic tones corresponding to an encoded signal stored in memory, and a display capable to displaying light flash sequences corresponding to an encoded signal stored in memory, said encoded signal presented upon receipt of a selected user input.

5. The secured area access system of claim 1, wherein the detector comprises a microphone or a photoelectric cell.

6. The secured area access system of claim 1, wherein the system further comprises a transponder signal learn module, adapted to receive and store in the memory an encoded transponder signal transmitted by a transponder after receiving an electric charge from an electric source, and further adapted to provide the encoded transponder signal to start a vehicle upon receipt of instruction from the access controller module.

7. The security access system of claim 5, wherein the transponder signal learn module sends a vehicle start signal.

8. A secured area access system comprising:
a) An optical and acoustic signal transmitter, the signal transmitter capable of encoding, generating and transmitting an optical and acoustic signal;
b) An optical and acoustic signal detector, the detector capable of receiving the encoded optical and acoustic signal transmitted by the signal transmitter and communicating said signal;
c) A processing module comprising a memory and a processor, the module capable of receiving and modulating the encoded optical and acoustic signal received from the detector, the modulated signal compared against an encoded area access signal stored in memory and if matched sending an unlock door signal to the secured are door lock mechanism.

9. The secured area access system of claim 8, wherein the signal transmitter is selected from the group consisting of: a cellular telephone; an audio player; a wireless telephone; a key FOB;
an LCD screen; an optical transmitter, or an audio transmitter.

10. The vehicle access security system of claim 9, wherein the encoded area access signal is modulated using a modulation format selected from the group consisting of: frequency modulation, amplitude modulation, phase modulation, quadrature phase shift keying, quadrature amplitude modulation, frequency shift keying, or; on-off keying.

11. The secured area access system of claim 8, wherein the signal transmitter comprises a memory, a processor, a speaker capable of generating acoustic tones corresponding to an encoded signal stored in memory, and a display capable to displaying light flash sequences corresponding to an encoded signal stored in memory, said encoded signal presented upon receipt of a selected user input.

12. The secured area access system of claim 8, wherein the detector comprises a microphone or a photoelectric cell.

13. The security area access system of claim 8, wherein the system further comprises a transponder signal learn module, adapted to receive and store in the memory an encoded transponder signal transmitted by a transponder after receiving an electric charge from an electric source.

14. The security access system of claim 13, wherein the transponder signal learn module sends a vehicle start signal.
